(19) United States
(12) Patent Application Publication
(10) Pub. No.: US 2019/0345358 A1
(43) Pub. Date: Nov. 14, 2019

(54) Omniphobic Surface Coatings

(71) Applicant: Universite de Mons, Mons (BE)

(72) Inventors: Joel De Coninck, Mons (BE); Connie Josefina Ocando Cordero, Mons (BE); Fabio Villa, Mons (BE)

(73) Assignee: Universite de Mons, Mons (BE)

(21) Appl. No.: 16/311,635

(22) PCT Filed: Jun. 20, 2017
(86) PCT No.: PCT/EP2017/065109

§ 371 Date: Dec. 19, 2018

(30) Foreign Application Priority Data
Jun. 20, 2016 (GB) 1610678.3
Dec. 30, 2016 (GB) 1622380.2

(51) Int. Cl. C09D 163/10; C09D 5/00; C09D 7/40

(52) U.S. Cl. CPC C09D 163/10; C09D 7/67; C09D 7/69; C09D 5/00

(57) ABSTRACT

The disclosure relates to omniphobic surface coatings including a solution of fluor-modified polymer and crystalline and/or semi-crystalline polymer and/or inorganic nanoparticles. The disclosure further relates to biphilic substrate surfaces for heat exchangers, including 50-95% of the surface showing a first solid-liquid contact angle and 5 to 50% of the surface showing a second solid-liquid contact angle, wherein the second liquid-solid contact angle is at least 10° higher than first liquid-solid contact angle, and the surface area of second contact angle includes a multitude of discrete surface areas of second contact angle dispersed over the substrate surface.

The present invention relates to omniphobic coating compositions and applications thereof.

Superhydrophobicity has gained considerable attention in surface science in the past 20 years. Superhydrophobicity is characterized by unique water-repellent properties, combined with a self-cleaning effect and reduced air-resistance. Reference is made to the review article by Chao-Hua Xue et al, Large-area fabrication of superhydrophobic surfaces for practical applications: an overview, in Sci. Technol. Adv. Mat. 11 (2010), 033002, p 1-15.

As used herein the term “superhydrophic surface” means a surface having i) a receding static water contact angle (a 5-50 μl water droplet on a flat surface in an essentially horizontal plane) of more than 130°, preferably more than 140° or more than 145°, more preferably from 145° to 160°, and ii) an advancing static water contact angle of more than 130°, preferably more than 140° or more than 145°, and more preferably from 145° to 160°, as measured by a Drop Shape Krüss Analyser and corresponding protocol and iii) preferably a water roll-off angle also called sliding angle (dynamic measure) or equivalently a hysteresis contact angle of less than 10°, preferably less than 6°, or equivalently (i) a static water contact angle (a 5-50 μl water droplet on a flat surface in an essentially horizontal plane) of more than 130°, preferably more than 140° or more than 145°, more preferably from 145° to 160°” ii) preferably a water roll-off angle also called sliding angle (dynamic measure) or equivalently a hysteresis contact angle of less than 10°, preferably less than 6°. When a pipette is used to provide a liquid drop on a flat horizontal surface, the liquid will form a contact angle. As the pipette deposits more liquid, the droplet will increase in volume, the contact angle will increase, but its three phase boundary will remain stationary until it suddenly advances outward. The contact angle the droplet had immediately before advancing outward is termed the advancing contact angle. The receding contact angle is measured by pumping the liquid back out of the droplet. The droplet will decrease in volume, the contact angle will decrease, but its three phase boundary will remain stationary until it suddenly recedes inward. The contact angle the droplet had immediately before receding inward is termed the receding contact angle. The difference between advancing and receding contact angles is termed contact angle hysteresis and can be used to characterize surface heterogeneity, roughness, and mobility. Surfaces that are not homogeneous will have domains which impede motion of the contact line. The slide angle is another dynamic measure of hydrophobicity and is measured by depositing a droplet on a surface and tilting the surface until the droplet begins to slide. See http://en.wikipedia.org/wiki/Superhydrophobe—Jan. 6, 2015.

Superhydrophobicity is known to be linked to the surface topography of the surface and several models have been designed to take surface aspects into consideration. While roughness is a useful indicator of the probability for a given surface to be superhydrophobic, it is, in practice, difficult to determine the superhydrophobic character on the basis of surface aspects alone. It is therefore preferred to define superhydrophobicity on the basis of the receding static water contact angle and water sliding angle. Moreover, the SuperHydrophobic Index which provides an indication of the percentage of surface area which is actually superhydrophobic is also an important aspect in considering the superhydrophobic property of a surface.—see R. Rioboo, B. Delattre, D. Duvivier, A. Vaillant and J. De Coninck, “Superhydrophobicity and liquid repellency of solutions on polypropylene”, Adv. Colloid. Interfac., 2012, 175, 1-10

More recently, omniphobicity, that is the feature of repellency towards all liquids, more specifically including water (hydrophobicity), alcohol and oily liquids (lipophobicity or oleophobicity), excluding liquid metals, has gained increased interest in certain applications, such as paper making, specialty materials, cosmetics, surface treatments and many more; see for instance K. Liu et al.; Bio-inspired superoleophobic and smart materials: Design, fabrication, and application, Progress in Materials Science 58 (2013) 503-564, and B. Tomsic et al, Sol-gel coating of cellulose fibres with anti-microbial and repellent properties: J Sol-Gel Sci Technol (2008) 47:44-57.

A lipophobic or oleophobic surface as used herein is understood to mean a surface having an oil contact angle (a 5-50 μl oil droplet on a flat surface in an essentially horizontal plane) of more than 70°, preferably more than 80° or more than 85°, more particularly more than 90°, more preferably from 90° to 160°, as measured by a Drop Shape Krüss Analyser and corresponding protocol.

It is known that ground crystallized polypropylene particles (including but not limited to particles of homopolymers, copolymers, such as ethylene-propylene block copolymers, random copolymers, graft copolymers, such as grafted with maleic anhydride or acrylic acid, halogenated polypropylene, surface oxidized polypropylene) show superhydrophobic properties; that is that ground crystallized polypropylene particles deposited or otherwise adhered onto a substrate confer superhydrophobic properties to the substrate surface . The polypropylene may be crystallized by evaporation of the solvent of a polypropylene solution and then ground to an appropriate granular size, such as comprised between 0.1 μm and 50 μm. Superhydrophobic polypropylene particles may be used in the preparation of construction materials, insulation materials, or in coatings.

US2010/0316806 discloses anti-frost coatings that form a hydrophilic and hydrophobic composite structure when applied on a substrate, such that the inner layer of the coating is a hydrophilic polymer layer and the surface layer is a hydrophobic or superhydrophobic polymer layer. It is explained that as a result of the hydrophobic or superhydrophobic surface, the contact area between water droplets and coated substrate is reduced and the heat conduction is slow, thereby lengthening the transformation of condensed water drops into frost crystals. Also, owing to the hydrophobicity or superhydrophobicity, water droplets tend to roll off the coated surface, thereby reducing the amount of formed water crystals. Further, the hydrophilic character of the inner layer will adsorb water drops that permeate into the coating and that water will exist in the form of a gel which tends to prevent frost crystal formation. The teaching of the document heavily relies on the synergy between the hygroscopicity of the hydrophilic inner layer and the hydrophobicity or superhydrophobicity of the outer layer.

It is known also to fluorinate epoxy polymers in order to form hydrophobic and oleophobic surface coatings. See for example Miccio, L. A., et al. “Partially fluorinated polymer networks: Surface and tribological properties.” Polymer 51.26 (2010): 6219-6226.)

EP-2028432 discloses biphilic surfaces for enhanced heat transfer, particularly in the pool boiling mode. The document describes a hydrophilic heat exchanging surface having a surface roughness inferior to 1 pm and comprising discrete hydrophobic areas.

The present invention now seeks to provide an omniphobic material, more specifically an omniphobic coating composition.

Another objective of the present invention is to provide a biphilic surface, preferably a surface that shows biphilicity towards all liquids, that is suitable for application in heat exchangers.

Another objective of the present invention is to provide a process for the preparation of such biphilic surfaces, preferably surfaces that show biphilicity towards all liquids.

The present invention now provides an omniphobic material comprising a selected epoxy-based polymer and fluorine molecules or radicals dispersed therein. The term omniphobic material as used herein means a material which provides an omniphobic surface.

According to a preferred embodiment, fluorine is grafted onto the epoxy-based polymer. It has been found that the fluorine-modified epoxy polymers of the invention show omniphobicity, that is repellency towards all liquids, more particularly excluding liquid metals but including water, water-like liquids, alcohol and oily liquids, more specifically liquids showing a surface tension higher than 20 mN/m, preferably higher than 25 mN/m, such as for instance oil, ethylene glycol, hexadecane, diiodomethane (as a matter of comparison, water shows a surface tension of 72, 40 mN/m). Further, it has been found that the fluorine grafted epoxy polymers show high durability, as they maintain their omniphobicity character over extended periods of time and/or over rather high numbers of repeated stresses or stress cycles. They show improved protection against corrosion and/or fouling, improved flexibility and service life.

As mentioned, omniphobic is used herein to designate the feature of being repellent towards all liquids, more particularly excluding liquid metals and including water, water-like liquids alcohol and oily liquids. In the case of water (hydrophobicity) the contact angle between a water droplet and the material surface is equal to or higher than 90°. In the case of oily liquids (lipophobicity or oleophobicity), the contact angle between a liquid droplet and the material surface is also equal to or higher than 90°. Omniphilic then must be understood to mean “having a contact angle below the relevant contact angles mentioned above.

According to the invention, the epoxy-based polymer is selected from biobased epoxydized material obtained from cardanol, for example NC-514. These materials may be cured with a curing agent (or hardener) selected from polyfunctional amines, acids, alcohols and thiols.

The present invention further provides an omniphobic surface coating comprising a polymer, fluorine molecules or radicals dispersed therein, and microparticles or nanoparticles of crystallized crystalline and/or semi-crystalline polymer dispersed therein or inorganic nanoparticles dispersed therein. Preferably, the omniphobic surface coating of the invention comprises a fluor-modified polymer and microparticles or nanoparticles of crystallized crystalline and/or semi-crystalline polymer dispersed therein or nanoparticles, dispersed therein.

The nanoparticles may be organic or inorganic or a mixture thereof. They may be treated or functionalized to increase the interface contact angle with a liquid. Such treatment may include a treatment with PDMS. The nanoparticles may further be treated for improved dispersion in the matrix polymer. Such treatment may include the formation of OH-groups, amine groups or oxyrane groups at their surface. If organic nanoparticles are used, robust particles are preferred in order to maintain the required surface properties over extended periods of time. Inorganic nanoparticles may also be used. Such inorganic nanoparticles may be selected from metal oxides, SiO2 or TiO2 for instance. As an example PDMS (polydimethylsiloxane) functionalized SiO2 nanoparticles may be used.

The fluor-modified polymers may be based on epoxy polymers selected from high and low molecular weight epoxy resins curable by homopolymerisation or with a curing agent (or hardener) selected from polyfunctional amines, acids, alcohols and thiols, preferably bisphenol A epoxy resin, bisphenol F epoxy resin, novolac epoxy resin, more preferably a biobased epoxydized material obtained from cardanol, for example NC-514, perfluoroalkene, perfluorocycloalkene, fluoroethylene, vinylfluoride, vinylidene fluoride, tetrafluoroethylene, chlorotrifluoroethylene, fluoropropylene, perfluoropropylvinylether, perfluoromethylvinylether or copolymers thereof.

The crystalline and/or semi-crystalline polymer and/or the nanoparticles defined hereabove, are advantageously present in a weight ratio to the fluor-modified polymer such that the polymer composition shows enhanced omniphobic properties. The relevant ratio depends on the type and nature of the polymers chosen. The skilled person, however, will have no difficulty in identifying the suitable ratio after a series of routine tests as will be explained below. It is known that such crystalline and/or semi-crystalline polymer and/or inorganic nanoparticles render hydrophobic surfaces superhydrophobic. The ratio advantageously ranges from 20:80 to 80:20, preferably from 25:75 to 75:25, or 25:70 to 50:50. As an example, a ratio of crystalline polypropylene:epoxy of 30:70 has been used and, in the case of inorganic nano-particles, a ratio of 37:63 has been used.

The crystalline and/or semi-crystalline polymer may advantageously be selected from polypropylene (PP), preferably isotactic polypropylene, carnauba wax, polycarbonate (PC), polymethylmethacrylate (PMMA), polylactic acid (PLA), polyhydroxyalkanoates (PHA), polyhydroxybutyrate (PHB), polyimide (PA 11, PA 410), starch-based plastics, cellulose-based plastics, and fibrin-based plastics. Polypropylene and more specifically isotactic polypropylene is preferred. Such materials form fragile solid superhydrophobic material when solvent is evaporated from a polymer solution of relevant polymers. It has been found that the superhydrophobic character is linked to the rearrangement of the crystal structure of said polymers during solvent evaporation. The crystalline and/or semi-crystalline polymer may include homopolymers, copolymers, such as ethylene-propylene block copolymers, random copolymers, graft copolymers, such as polypropylene or polylactic acid grafted with maleic anhydride or acrylic acid, halogenated polymers, surface oxidized polymers, and other modifications known to the skilled person. The relevant polymers may be semi-crystalline, for example having a crystallinity index or degree of crystallinity of more than 30%, preferably more than 50%, more preferably greater than 75%, notably more than 80%. Said crystallinity index is usually defined as the percentage of the volume of the material that is actually crystalline and may be determined for example by solid NMR, X-ray diffraction or DSC.

The molecular weight of the crystalline or semi-crystalline polymer may vary within a large range of molecular weights, such as 1000 to 1000000 Da, preferably between 2000 and 200000 or more preferably between 2500 and 100000 Da.

It is well understood by the skilled person that the melting point of the relevant crystalline or semi-crystalline polymer should be close to, preferably below, the boiling point of the solvent.

The nanoparticles are understood to show dimensions in the range 1×10⁻⁹ m to 1×10⁻⁷ m and may be selected from nano-sized SiO2 and metal oxides. These materials are commercially available, see for instance pyrogenic silica HDK-H18.

According to a preferred embodiment, polymers are selected that are soluble in solvents selected from xylene, preferably p-xylene, or xylene based solvent systems, methyl ethyl ketone (see example), tetrahydrofuran, toluene, dibasic esters, DMSO, or limonene or butylal or a mixture thereof.

The polymer compositions may comprise one or more additives and/or agents notably pigments, anti-fouling agents, wetting agents, thickening agents, hardening agents, toughening agents, plasticizers and stabilizers, including agents improving the resistance to UV radiation, and additives improving the antibacterial properties.

The invention coatings provide unique liquid-repellent properties including self-cleaning properties, anti-icing and anti-condensation properties, impacting droplet rebounce combined with reduced air-resistance. In addition, these properties are durable as they are preserved over extended periods of time and/or over repeated stress cycles.

According to a preferred embodiment, the above coating may comprise an overcoat comprising the above defined polymer composition, more preferably the fluor-modified polymer based on epoxy polymers selected from high and low molecular weight epoxy resins curable by homopolymerisation or with a curing agent (or hardener) selected from polyfunctional amines, acids, alcohols and thiols, preferably bisphenol A epoxy resin, bisphenol F epoxy resin, novolac epoxy resin, more preferably a biobased epoxydized material obtained from cardanol, for example NC-514, perfluoroalkene, perfluorocycloalkene, fluoroethylene, vinylfluoride, vinylidene fluoride, tetrafluoroethylene, chlorotrifluoroethylene, fluoropropylene, perfluoropropylvinylether, perfluoromethylvinylether or copolymers thereof.

Practical applications of such omniphobic coatings are diverse and range from stain-free and/or spill-resistant clothing to corrosion resistant and/or fouling resistant coatings and chemical repellents.

In another aspect, the present invention also relates to omniphobic coating compositions which comprise a solution of fluor-modified polymer and possibly of crystalline and/or semi-crystalline polymer and/or inorganic nanoparticles. Preferably, the solvent is selected from xylene, a xylene based solvent system, methyl ethyl ketone, tetrahydrofuran, toluene, dibasic esters DMSO, or limonene or a mixture thereof. The coating composition advantageously comprises the crystalline and/or semi-crystalline polymer in a weight ratio to the fluor-modified polymer of 20:80 to 80:20, preferably 25:75 to 75:25 or 25:70 to 50:50.

The coating compositions of the invention are particularly suitable to form an omniphobic coating of substrates, that is articles, notably: construction materials, for example concrete or cement based elements or coatings, bricks, tiles, or roof covering sheets; steel elements or covers, self-cleaning textiles, more specifically sportswear, swimwear; self-cleaning matrasses or matrass covers.

It has been found that the hydrophobic polymer unexpectedly becomes superhydrophic when combined with crystalline or semicrystalline polymer particles distributed within the hydrophobic polymer matrix. The crystalline or semicrystalline polymer particles may be obtained by appropriate evaporation of the solvent of a polymer solution, under suitable conditions, in order to allow for crystal rearrangement which leads to crystal or semi-crystal polymer particles. If so required, the crystal or semicrystal particles are ground to obtain the appropriate size distribution. The crystal particles may show weight average particle sizes of less than 1000 μm, preferably less than 500 μm, or less than 100 μm, more preferably between 0.1 and 50 μm. Particles showing a particle size of 5 μm or less are preferably removed.

The solvent evaporation may be effected at a minimum temperature of about 15° C. below the melting point of the crystalline and/or semi-crystalline polymer, preferably at a minimum temperature of about 10° C. below the melting point of the crystalline and/or semi-crystalline polymer, more preferably a minimum temperature of about 5° C. below the melting point of the crystalline and/or semi-crystalline polymer. The maximum temperature at which evaporation of solvent is effected such as to allow for rearrangement of the crystal structure of the crystalline and/or semi-crystalline polymer and formation of nanoparticles and/or microparticles of crystallized crystalline or semi-crystalline polymer advantageously may be 25° C. beyond the melting point of the crystalline or semi-crystalline polymer, preferable 15° C. beyond the melting point of the crystalline or semi-crystalline polymer. Most preferably, the solvent evaporation according to the invention is effected in a temperature ranging from 5-10° C. below to 5-10° C. above melting point of the relevant crystalline or semi-crystalline polymer in the solution.

The solvent evaporation may further be followed by drying at a temperature below the melting point of the crystalline and/or semi-crystalline polymer, preferably below the softening point of the crystalline and/or semi-crystalline polymer, more preferably at least 10° C. below said melting point, even more preferably at least 20° C. below said melting point.

Evaporation and drying are preferably performed at atmospheric pressure. A pressure slightly above atmospheric is also possible, although not particularly preferred for practical reasons, it being understood that applying a pressure above atmospheric in the course of an industrial manufacturing process requires more expensive equipment, hence rendering the whole process more costly.

If so required, crystalline or semi-crystalline polymer particles obtained by appropriate solvent evaporation and/or the inorganic nanoparticles may further be ground to appropriate size. The grinding equipment is chosen and/or operated such that the polymer particles do not reach the melting temperature, and preferably stay below a temperature of at least 5°, more preferably 10° or even 15° C. below melting temperature of the crystallites.

The coating composition may be deposited onto a substrate and subjected to the process steps as described here above. After solvent evaporation, the coating may still contain less than 5 w % solvent, preferably less than 3 w % solvent. The coated substrate may then be subjected to further drying.

The coating composition may be applied onto the substrate by spraying, knife coating, dip coating or spin coating.

Surprisingly, when modifying the ratio of crystal or semi-crystal polymer and/or nanoparticles to matrix polymer, a dramatic change in surface wettability is observed in a very narrow range of crystal or semi-crystal polymer or nanoparticles fraction. It has been found that the crystal or semi-crystal polymer and/or nanoparticle fraction at which this dramatic change in surface wettability occurs may vary, depending on the polymers used.

The above coating operation may be repeated several times, preferably two or three times in order to form a multi-layered coating.

In an alternative embodiment, the above coating may be overcoated with a layer of epoxy resin, preferably fluor-modified epoxy resin. The coating retains its omniphobic character while showing improved resistance to abrasion and wear.

According to yet another aspect, the invention provides a biphilic substrate surface, such as for instance a heat exchanging surface of a pool boiling heat exchanger, comprising 50.0-99.9% of the surface showing a first degree of wettability defined by a first liquid-solid contact angle and 0.1 to 50.0% of the surface showing a second degree of wettability to the said liquid, wherein the second degree of wettability is defined by a second liquid-solid contact angle at least 10° higher than first liquid-solid contact angle, and the surface area of second degree of wettability comprising a multitude of discrete surface areas of second degree of wettability dispersed over the substrate surface. The surface area showing the second degree of wettability is formed by a surface material selected from

(i) a polymer material comprising a matrix of amorphous polymer showing a contact angle with said liquid higher than 15°, preferably higher than 25° or higher than 35° or 45°, more preferably higher than 55° or 65°, even more preferably higher than 75° or 85°, more particularly higher than 90° and microparticles or nanoparticles of crystallized crystalline and/or semi-crystalline polymer dispersed therein, wherein the crystalline and/or semi-crystalline polymer is present in a weight ratio to said amorphous matrix polymer such that the polymer surface material shows a significantly increased value for the contact angle to said liquid, and wherein the crystalline and/or semi-crystalline polymer is selected from polypropylene (PP), preferably isotactic polypropylene, carnauba wax, polycarbonate (PC), polymethylmethacrylate (PMMA), polylactic acid (PLA), polyhydroxyalkanoates (PHA), polyhydroxybutyrate (PHB), polyimide (PA 11, PA 410), starch-based plastics, cellulose-based plastics, and fibrin-based plastics;

(ii) a polymer material comprising a matrix of amorphous polymer showing a contact angle higher than 15°, preferably higher than 25° or higher than 35° or 45°, more preferably higher than 55° or 65°, even more preferably higher than 75° or 85°, more particularly higher than 90° and nanoparticles,; or

(iii) fluorine-modified epoxy-based polymer.

The ratio of micro- or nano-particles to amorphous matrix polymer depends on the type and nature of the polymers chosen. The skilled person, however, will have no difficulty in identifying the suitable ratio after a series of routine tests. It has been found that for a PP/PVA blend for example, the receding water contact angle suddenly jumps from about 20° to more than 135° at about 30 wt % PP. In a PP/PCP blend, the change occurs between 60 and 70 wt % PP. In a PP/PS blend, the change occurs at about 25 wt % PP. All that can be stated is that the surface material may comprise the crystalline and/or semi-crystalline polymer in a weight ratio to the amorphous polymer of 20:80 to 80:20, preferably 25:75 to 75:25, or 30:70 to 70:30, and always in such proportion that the polymer composition shows significantly increased contact angle. In the case of nanoparticles as defined herein, the same ratios apply.

The amorphous matrix polymer may be selected from polystyrene (PS), polyethylene (PE), preferably low density polyethylene (LDPE), and polychloroprene (PCP), and from polymers which do not show a high interface contact angle (higher than 15°, 25°, 35°, 45°, 55°, 65°, 75°, 85° or 90°) with relevant liquid by themselves but which are functionalized such as to show high contact angle, like polyurethane (PU), polyvinylacetate (PVA), polyacrylic acid, polyacrylate, and epoxy resins. Functionalization of polymers may be obtained by covalent bonds as is known in the art, e.g. fluorinated acid bonding, perfluoroalkyl end capping. Functionalization may also be obtained by mixing with copolymers, such as PTFEA-PEO, PTFEA-PGA, PCL-PDMS-PCL (PTFEA=polytetrafluoroethylene; PEO=polyethylene glycol; PGA=polyglycolic acid; PCL=polycaprolactone; PDMS=polydimethylsiloxane) or poly(heptadecafluorodecyl acrylate)-b-poly(caprolactone) (PaF-b-PCL), that show relatively high (higher than 15°, preferably higher than 25° or higher than 35° or 45°, more preferably higher than 55° or 65°, even more preferably higher than 75° or 85°, more particularly higher than 90°) interface contact angles with relevant liquid.

As stated, when modifying the ratio of crystal or semi-crystal polymer and/or nanoparticles to matrix polymer, a dramatic change in surface wettability is observed in a very narrow range of crystal or semi-crystal polymer or nanoparticles fraction. The crystal or semi-crystal polymer and/or nanoparticle fraction at which this dramatic change in surface wettability occurs may vary, depending on the polymers used. The skilled person will find the relevant sudden increase in contact angle by routine experimentation. The dramatic or significant increase in contact angle has been found to be at least 10°, at least 30 degrees or at least 40° or 50°; it is a sudden increase that raises the contact angle approx. the maximum that can be reached for matric polymer/particle combination.

Preferably, the nanoparticles are dispersed within the matrix polymer. The crystalline and/or semi-crystalline polymer preferably is polypropylene and more specifically isotactic polypropylene is preferred. Such materials form fragile solid superhydrophobic material when solvent is evaporated from a polymer solution of relevant polymers. It has been found that the superhydrophobic character is linked to the rearrangement of the crystal structure of said polymers during solvent evaporation. The crystalline and/or semi-crystalline polymer may include homopolymers, copolymers, such as ethylene-propylene block copolymers, random copolymers, graft copolymers, such as polypropylene or polylactic acid grafted with maleic anhydride or acrylic acid, halogenated polymers, surface oxidized polymers, and other modifications known to the skilled person. The relevant polymers may be semi-crystalline, for example having a crystallinity index or degree of crystallinity of more than 30%, preferably more than 50%, more preferably greater than 75%, notably more than 80%. Said crystallinity index is usually defined as the percentage of the volume of the material that is actually crystalline and may be determined for example by solid NMR, X-ray diffraction or DSC.

The molecular weight of the crystalline or semi-crystalline polymer may vary within a large range of molecular weights, such as 1000 to 1000000 g/mol, preferably between 5000 and 500000 or more preferably between 5000 and 300000 g/mol.

As used herein, the term “amorphous polymer” means a polymer that is entirely amorphous or crystalline with a degree of crystallinity below 30%.

According to a preferred embodiment, the amorphous matrix polymer comprises an epoxy resin showing an interface contact angle of more than 35°, preferably more than 55°, more than 65° or more than 75° or 85° or even 90° with the liquid it will be contacted with. Epoxy resins inherently are hydrophilic (i.e. when contacted with water) but may be rendered hydrophobic by chemical modification, crosslinking or other methods known per se. Epoxy resins may be selected from high and low molecular weight epoxy resins curable by homopolymerisation or with a curing agent (or hardener) selected from polyfunctional amines, acids, alcohols and thiols. By way of example, suitable epoxy resins include bisphenol A epoxy resin, bisphenol F epoxy resin, novolac epoxy resin. A preferred hydrophobic epoxy resin is a biobased epoxydized material obtained from cardanol, for example NC-514.

According to a preferred embodiment, polymers are selected that are soluble in solvents selected from xylene, preferably p-xylene, or xylene based solvent systems, methyl ethyl ketone (see example), DMSO, toluene, THF, butylal, limonene and mixtures thereof.

The polymer surface material may comprise one or more additives and/or agents notably pigments, anti-fouling agents, wetting agents, thickening agents, hardening agents, toughening agents, plasticizers and stabilizers.

It is known that the difference of contact angle between the surface areas of first and second degree of wettability has an impact on the properties of the heat exchanger. Preferably, the difference of contact angle is at least 20°, more preferably at least 30°, more preferably at least 40°, more preferably at least 50°, more preferably at least 60°, more preferably at least 70°, for example at least 80°, at least 90°, at least 100°, at least 120°, at least 150°.

It has been found that such a biphilic surface is particularly suitable in a pool boiling heat exchanger. According to a preferred embodiment, the surface materials are chosen such that the biphilic surface may be used in conjunction with all suitable heat exchanging fluids or refrigerants as listed in Wikipedia (https://en.wikipedia.org/wiki/List_of_refrigerants—Dec. 20, 2016) or at https://www.1-act.com/operating-temperature-range/(Dec. 20, 2016), including water and oily liquids, such as methanol for instance. The relevant heat exchanging fluids are selected according to their boiling temperature and the temperature of the surface to be cooled. The invention biphilic substrate surface allows to control the boiling onset and shows improved critical heat flux.

The invention coating and/or biphilic surfaces are also suitable in flow boiling applications, that is heat transfer in by way of phase change in a channel or pipe. Heat transfer may be improved and drag forces as well as pressure loss may be reduced.

It has further been found that such surfaces show high resistance and durability. Compared to known heat exchanging surfaces, they may be subjected to increased numbers of stress cycles, meaning heat exchanging cycles. As a result, maintenance costs and/or replacement costs of heat exchangers as per the invention are reduced.

According to the invention, the surface material showing the second degree of wettability may be a coating applied onto and bonded to the substrate surface by way of an intermediate binding layer.

The surface area showing a first degree of wettability may be an untreated or treated metallic surface, preferably with a surface roughness below 1 μm, such as for instance stainless steel or aluminium or copper. It may also be a substrate coated with a coating that shows the required wettability character.

The surface coating showing the second contact angle and dispersed as discrete areas over the substrate surface, may be applied by different techniques known per se, for instance printing techniques, film deposition or techniques based on etching, preferably by a spray technique. Compared to prior art processes for manufacturing biphilic surfaces; involving complex and onerous process steps like etching and printing techniques, the present invention provides a simple process comprising spraying a solution of the relevant polymer composition at a distance from the target surface and at a rate such as to spray spots of coating composition showing the second degree of wettability onto the substrate target surface, the total surface area showing the second degree of wettability making up 5 to 50% of the total substrate surface. The skilled person will find the appropriate spray distance and rate by routine experimentation. As a guidance, a nozzle (BADGER Air-Brush, model 360 Universal-U.S. Pat. Nos. 5,799,157, 5,366,158) operated at 20 psi has been used at a distance of 50 cm to 1.20 m to spray 0.25 to 0.50 ml of omniphobic coating composition.

The spray composition may comprise a solution of amorphous matrix polymer, and of crystalline and/or semi-crystalline polymer if appropriate and/or inorganic nanoparticles, if desired. Preferably, the solvent is selected from xylene, a xylene based solvent system, methyl ethyl ketone, tetrahydrofuran, toluene, dibasic esters, DMSO, limonene, butylal or a mixture thereof.

The polymer concentration in the solvent of the spray composition is advantageously below 25 wt %, preferably between 5 and 15 wt %, more particularly around 10 wt %, prior to solvent evaporation. The coating composition also may comprise additives and/or agents notably as mentioned above in connection with the polymer composition.

The spray composition may be applied to the substrate and the solvent is then allowed to evaporate at a temperature comprised between 10 and 70° C., preferably between 10 and 50° C. After solvent evaporation, the coating may still contain less than 5 w % solvent, preferably less than 3 w % solvent. The coated substrate may then be subjected to further drying. A curing step may be provided for too.

Evaporation and drying are preferably performed at atmospheric pressure. A pressure slightly above atmospheric is also possible, although not particularly preferred for practical reasons, it being understood that applying a pressure above atmospheric in the course of an industrial manufacturing process requires more expensive equipment, hence rendering the whole process more costly.

The provision of one pot solutions for surface treatment in order to render surfaces omniphobic by simple process step(s) is of particular interest. The invention coating compositions may thus be easily applied on all types of materials, including metals, polymeric materials and textiles.

The present invention will be described in more details below, by way of example only, with reference to the drawings of which

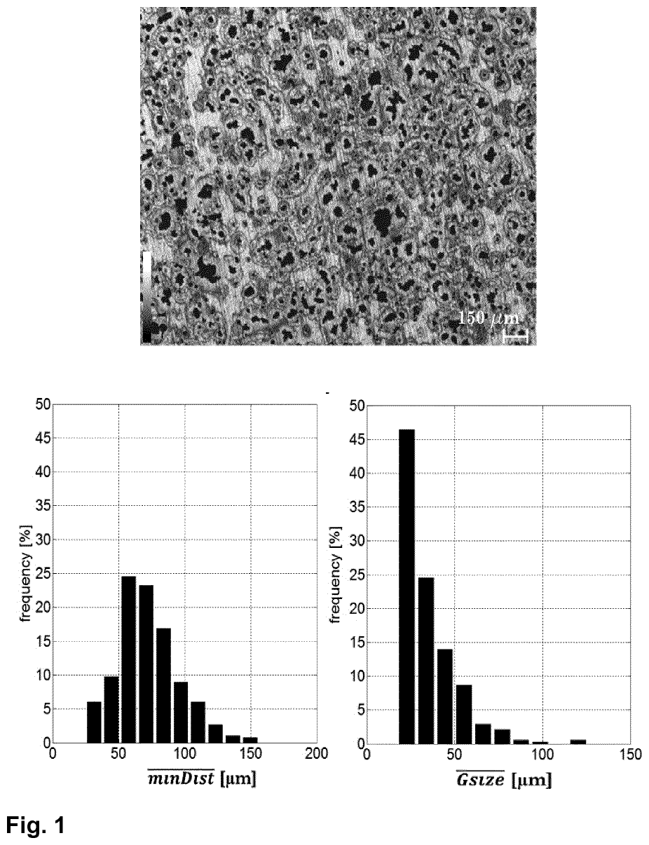

FIG. 1 shows image processing to evaluate grain size and distribution on the surface; and

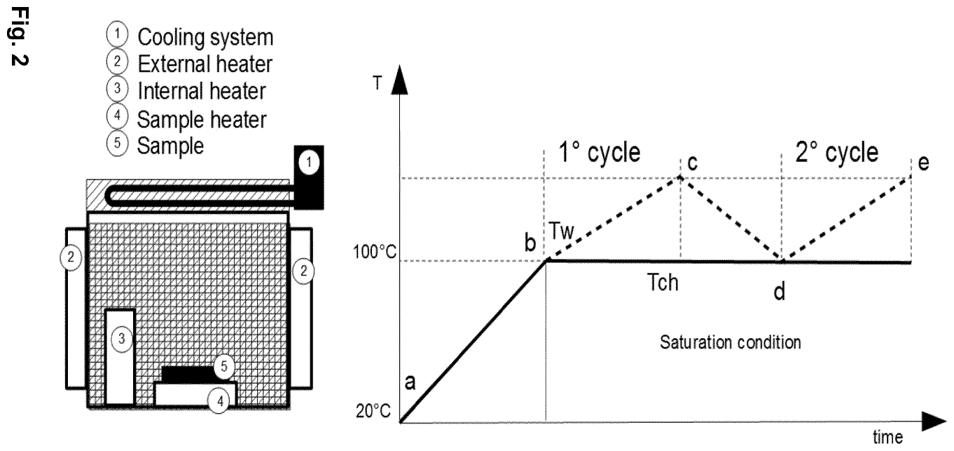

FIG. 2 is a schematic representation of the test set up and procedure;

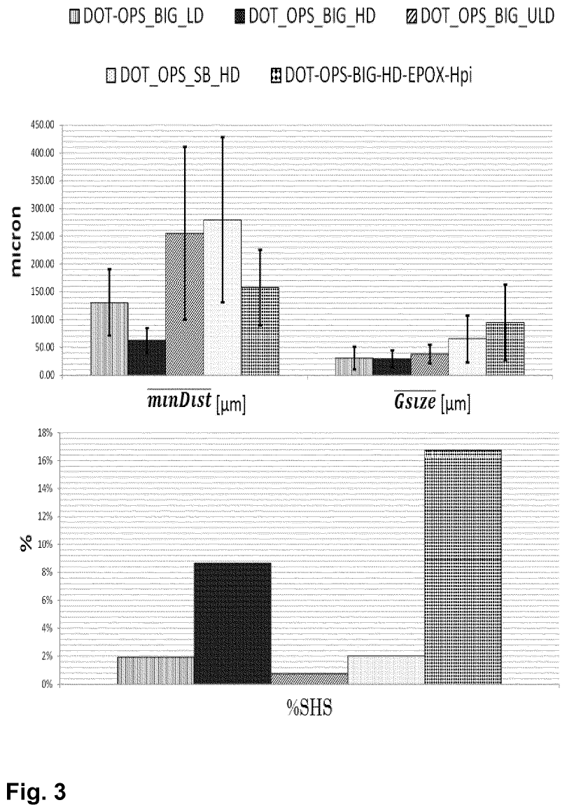

FIG. 3 is a graphic representation of average grains size, average minimum distance and percentage superhydrophobic surface coverage;

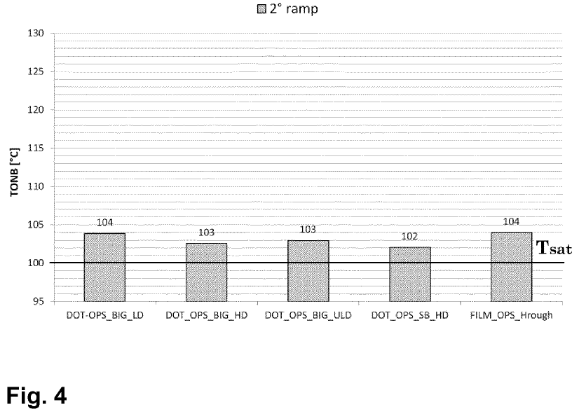

FIG. 4 shows T_{ONB} for the various coatings evaluated in Example 3;

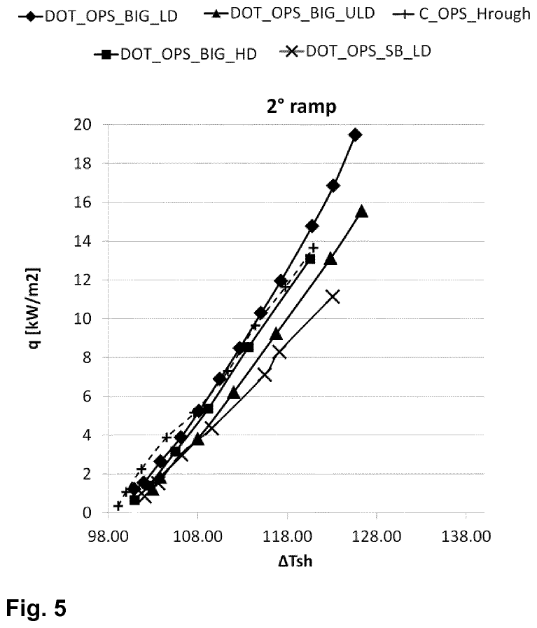

FIG. 5 shows the heat flux as a function of wall temperature during first and second cycle for tested surface coatings;

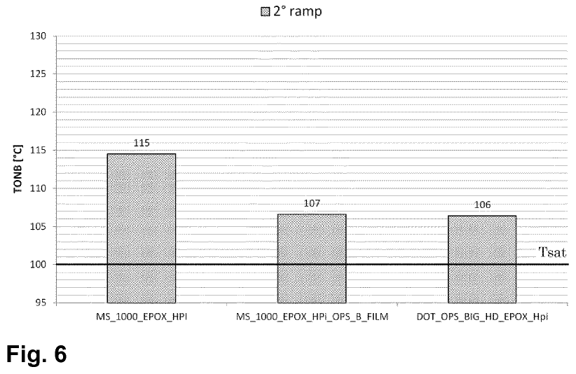

FIG. 6 graphically represents T_{ONB} for the coatings of Example 4 in water;

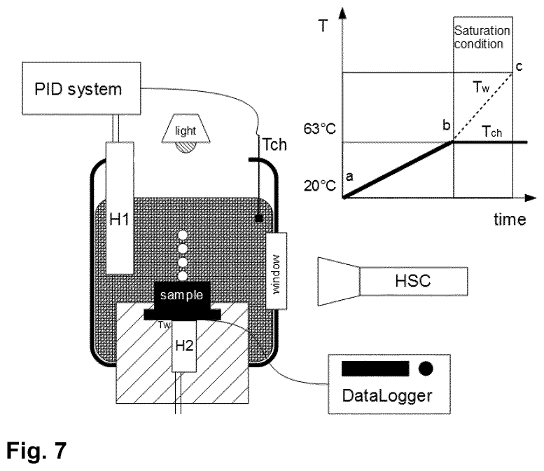

FIG. 7 is a schematic representation of a methanol pool boiling test apparatus;

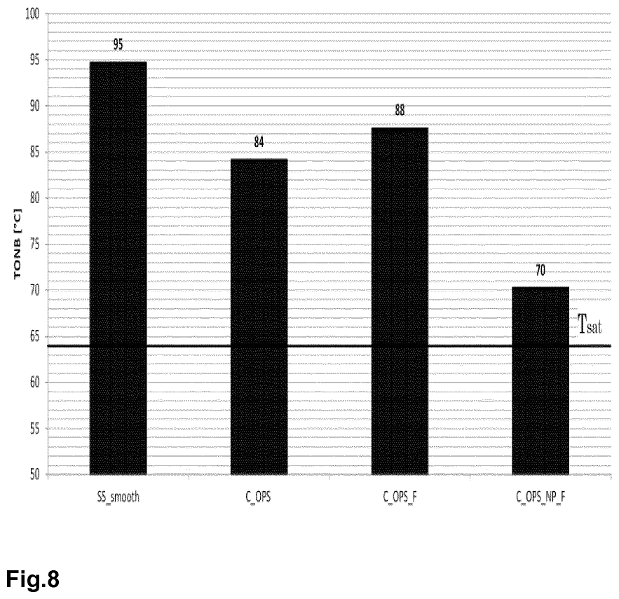

FIG. 8 graphically represents T_{ONB} for coatings in methanol;

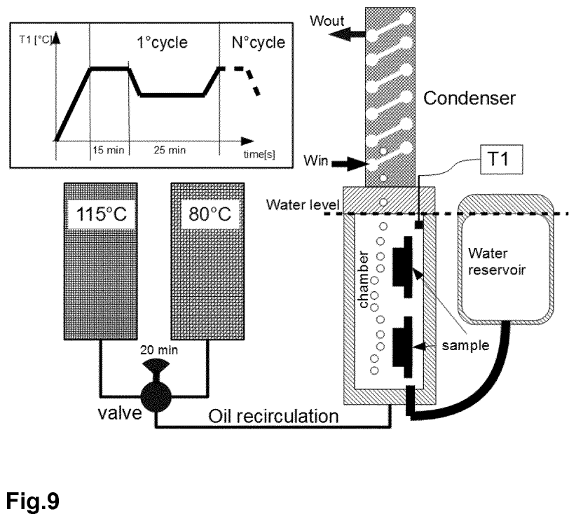

FIG. 9 shows experimental set up and temperature cycle in thermal cycling conditions; and

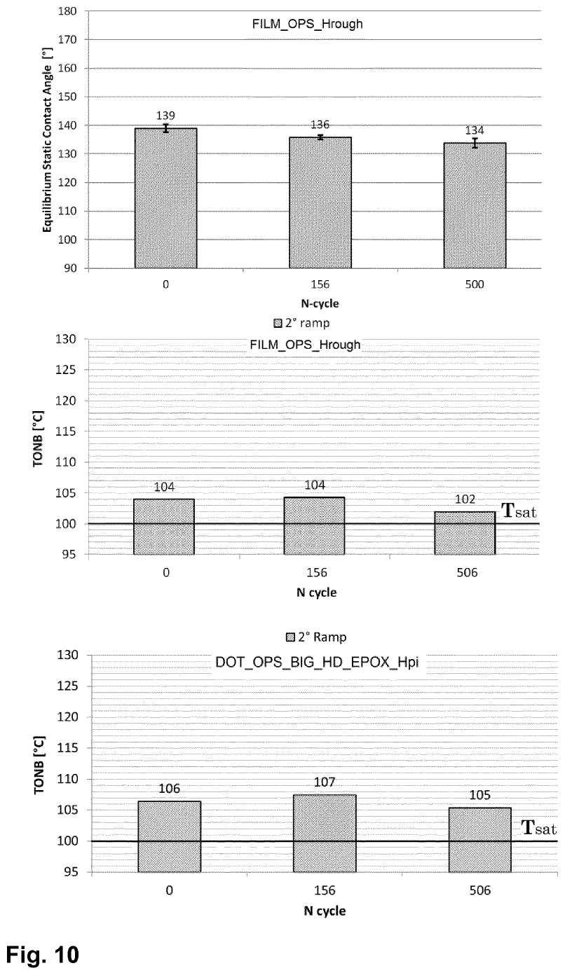

FIG. 10 shows T_{ONB} and Equilibrium Static Contact Angle for coatings of Example 6

### EXAMPLE 1

The following solutions were prepared:

Superhydrophobic polymeric composition (OPS—PP/epoxy suspension or dispersion):

In order to prepare an epoxy solution containing 30 wt % of Polypropylene (PP), 1.7 g of PP and 3.61 g of NC514 were dissolved in 50 ml xylene and heated under reflux at 135° C. under continuous stirring until a homogeneous solution was obtained. Next, an amine monomer (IPDA) dissolved in 5 ml xylene was combined with the PP solution at room temperature and mixed at 12000 rpm in a high velocity homogenizer (SilentCrusher M from Heidolph) for 5 min.

Fluorinated superhydrophobic polymer solution (about 5 wt % F in host polymer—F5OPS):

First, a partially fluorinated amine monomer was prepared by reacting 0.125 ml of fluorinated epoxy oligomer (heptadecafluorononyl oxirane, Sigma-Aldrich) with a known excess of 0.618 ml of IPDA at about 100° C. for 120 min, in a sealed tube.

Next, in order to prepare a fluorinated epoxy solution containing 30 wt % of Polypropylene (PP), 2.2 g of PP and 4.305 g of NC514 were dissolved in 64 ml xylene and heated under reflux at 135° C. under continuous stirring until a homogeneous solution was obtained. Thereafter, the previous solution of partially fluorinated amine monomer dissolved in 8 ml THF was combined with the PP solution at room temperature and mixed at 12000 rpm in a high velocity homogenizer (SilentCrusher M from Heidolph) for 5 min.

Neat cardanol (SC):

A solution of epoxy cardanol was prepared by mixing 3.61 g NC514 and 0.46 g IPDA with 15 ml xylene at RT until a homogeneous solution was obtained (using manual mixing by spatula).

Preparation of fluorinated epoxy (about 15 wt % F in host polymer)—FC15:

First, a partially fluorinated amine monomer was prepared by reaction of 0.343 ml of fluorinated epoxy oligomer (heptadecafluorononyl oxirane, Sigma-Aldrich) with a known excess of 0.609 ml of IPDA at about 100° C. for 120 min, in a sealed tube. Thereafter, the previous solution of partially fluorinated amine monomer was dissolved in 5 ml toluene and 5 ml THF. 3.936 g NC514 and 20 ml xylene were mixed at room temperature until a homogeneous solution was obtained (using manual mixing by spatula). The solution of partially fluorinated amine monomer was added to the previous solution and mixed (using manual mixing by spatula).

Preparation of fluorinated epoxy (about 5 wt % F in host polymer) FC5:

First, a partially fluorinated amine monomer was prepared by reaction of 0.250 ml of fluorinated epoxy oligomer (heptadecafluorononyl oxirane, Sigma-Aldrich) with a known excess of 1.236 ml of IPDA at about 100° C. for 120 min, in a sealed tube.

Thereafter, the previous solution of partially fluorinated amine monomer was dissolved in 8 ml toluene and 2 ml THF. Next, 8.62 g NC514 and 200 ml xylene were mixed at room temperature until a homogeneous solution was obtained (using manual mixing by spatula). Further, the solution of partially fluorinated amine monomer was added to the previous solution and mixed (using manual mixing by spatula).

Preparation of fluorinated epoxy (about 5 wt % F in host polymer) containing 37 wt % nanoparticles (FC5NP37):

A partially fluorinated amine monomer was prepared by reaction of 0.250 ml of fluorinated epoxy oligomer (heptadecafluorononyl oxirane, Sigma-Aldrich) with a known excess of 1.236 ml of IPDA at about 100° C. for 120 min, in a sealed tube. Thereafter, the previous solution of partially fluorinated amine monomer was dissolved in 8 ml toluene and 2 ml THF. Next, 6.0 g of hydrophobic SiO₂ (HDK18) nanoparticles were manually mixed with 8.62 g NC514 and 200 ml xylene at room temperature and then mixed at 12000 rpm in a high velocity homogenizer (SilentCrusher M from Heidolph) for 1 min. The solution of partially fluorinated amine monomer was added to the previous dispersion of nanoparticles and epoxy and mixed at 12000 rpm in a high velocity homogenizer SilentCrusher M from Heidolph) for 2 min. Finally, the solution was sonicated for 30 min and ultrasonicated at 40% amplitude during 1 min 30 sec.

Preparation of a multi-layered coating over a steel sample by spraying:

Several layers of the different solutions were sprayed (Badger Air-Brush 360-Universal) onto the target surface as follows (Sample code: C_OPS_NP_F)

| | | | Spray gun |
|---|---|---|---|
| Layer | Solution | Aliquot (ml) | distance |
| 1 | FC15 | 1 | 30 |
| 2 | FC5NP37 | 1 | 30 |
| 3 | F5OPS | 1 | 40 |
| 4 | FC5NP37 | 1 | 40 |
| 5 | FC5 | 1 | 40 |
| 6 | F5OPS | 1 | 40 |
| 7 | FC5NP37 | 1 | 40 |
| 8 | FC5 | 1 | 40 |
| 9 | F5OPS | 1 | 40 |
| 10 | FC5NP37 | 1 | 40 |
| 11 | FC5 | 1 | 40 |
| 12 | FC5NP37 | 1 | 40 |
| 13 | FC5 | 4 | 40 |

The final coating was cured at 80° C. during 24 h. The static contact angle of hexadecane on the final coating was 121.8°+/−0.7°.

The same experiment was repeated with the following layers (Sample code: C_OPS):

| | | | Spray gun |
|---|---|---|---|
| Layer | Solution | Aliquot (ml) | distance |
| 1 | SC | 1 | 20 |
| 2 | OPS | 1 | 30 |
| 3 | SC | 1 | 40 |
| 4 | OPS | 1 | 40 |
| 5 | SC | 1 | 40 |
| 6 | OPS | 1 | 40 |
| 7 | SC | 1 | 40 |

The final coating was cured at 60° C. during 16 h. The final coating was completely wetted with hexadecane—no contact angle

The same experiment was repeated with the following layers (Sample code: C_OPS_F):

| | | | Spray gun |
|---|---|---|---|
| Layer | Solution | Aliquot (ml) | distance |
| 1 | SC | 1 | 40 |
| 2 | SC | 1 | 40 |
| 3 | FC5 | 1 | 40 |
| 4 | FC5 | 1 | 40 |
| 5 | F5OPS | 1 | 40 |
| 6 | FC5 | 1 | 30 |
| 7 | F5OPS | 1 | 40 |
| 8 | FC5 | 1 | 30 |
| 9 | F5OPS | 1 | 40 |
| 10 | FC5 | 4 | 30 |

The final coating was cured at 80° C. for 24 h. The static contact angle of hexadecane on the final coating was 123.7°+/−1.7°.

### EXAMPLE 2

A two neck round bottom flask of 100 ml was charged with 1.7 g of isotactic polypropylene and 40 ml of xylene. The amount of solvent used was varied as shown in Table 1 in order to generate different sizes of crystalline PP grains. The flask was connected to Liebig condenser and a magnetic stirrer introduced into the flask. The flask was heated at 135° C. in an oil bath and the temperature was controlled by a probe sensor in direct contact with the solution. The mixture was heated under reflux under continuous stirring until a homogenous solution was obtained. Thereafter, the solution was cooled at room temperature under stirring.

TABLE 1
Solutions of polymeric surface material

| Solution | Composition |
|---|---|
| BIG | 30 wt % PP by Total, Mw 235000 g/mol in 40 ml Xylene |
| SB | 30 wt % PP by Total, Mw 235000 g/mol in 25 ml Xylene |

3.61 g of NC-514(epoxy-cardanol resin) were dissolved in 10 ml xylene in a 20 ml glass bottle equipped with a magnetic stirrer.

Both solutions were combined and heated at 135° C. under reflux, under continuous stirring until a homogenous solution was obtained. Which was then cooled at 100° C. under stirring and transferred into a 100 ml glass bottle. The solution was then further cooled at room temperature under manual stirring and crushed in high velocity homogenizer (Silent Crusher M from Heidolph) during 3 min, during which the crusher velocity was slowly increased from 5000 rpm to 12000 rpm in the case of BIG solution and from 5000 rpm to 7000 in the case of SB solution.

0.46 g of isophorone diamine curing agent were dissolved in 5 ml xylene in a 20 ml glass bottle, and the solution was combined with the above crushed solution. A further 2 minutes crushing cycle was carried out.

A spraying method was designed in order to obtain a heterogeneous coated surface with biphilic characteristics comprising superhydrophobic spots (comprising PP grains) dispersed on top of a hydrophilic surface (stainless steel). For this purpose, the distance of the spray nozzle from the target surface as well as the aliquot of solution were varied as per Table 2. This way of proceeding allowed to control the distance between superhydrophobic spots as well as the percentage of stainless steel substrate surface covered with superhydrophobic spots. The obtained coatings were allowed to cure, in an oven controlled at 60° C., during 16 hours. The microstructural aspects of the coatings were evaluated by optical profilometry—see Table 2.

In the above table:

DOT_OPS_BIG_HD means spots of superhydrophobic surface material BIG (as per Table 1) dispersed with high density on substrate surface;

DOT_OPS_BIG_LD means spots of superhydrophobic surface material BIG (as per Table 1) dispersed with low density on substrate surface;

DOT_OPS_BIG_ULD means spots of superhydrophobic surface material BIG (as per Table 1) dispersed with ultra-low density on substrate surface; and

DOT_OPS_SB_LD means spots of superhydrophobic surface material SB (as per Table 1) dispersed with low density on substrate surface

The heterogeneous or biphilic surface obtained is characterized by
G̅s̅i̅z̅e̅ which stands for average equivalent diameter of the grains on sample surface—see FIG. 1
m̅i̅n̅D̅i̅s̅t̅ which stands for average of the minimum distance between grains—see FIG. 1
% SHS which stands for percent surface occupied by the spots of superhydrophobic surface material

These values are obtained by 5 pictures of each surface; a Matlab script is performed to evaluate the average and the standard deviation. An example is shown in FIG. 1.

### EXAMPLE 3

### Evaluation of Biphilic Surfaces of the Invention in Pool Boiling Applications

The boiling chamber (FIG. 2) is made of aluminium and several heaters are applied on it, in order to maintain constant thermal conditions for the water contained within the chamber. An internal heater (80W) is initially used to heat up the pure water. Moreover, three external heating tapes and a K-thermocouple are placed in the pure water are placed on the walls of the chamber and are connected to a PID controller in order to balance any potential thermal leakages. These external heating tapes work in conjunction with a cooling system (air coils), in order to control the temperature of the chamber at the desired level during the experiment. A heat flux meter with 3 embedded T-thermocouples (Captec, France) is placed between the copper and the tested surface. A pressure gauge is connected to the chamber to measure its pressure. The boiling chamber is connected to bellows in order to modify the internal pressure. All the thermocouples, pressure gauge and heat flux meter are connected to a computer using a data acquisition system (Agilent A34970A data acquisition/switch unit, USA). The measuring accuracy of the T and K-thermocouples is 0.5 K, accuracy of the pressure gauge is 5 hPa.

The test procedure is schematically shown in FIG. 2. Firstly, the chamber was vacuumed down to 70 mbar before adding water in order to remove air and adsorbed gases inside the box. When the chamber was filled by degassed water, the temperature of the complete system (chamber and sample) was increased up to the saturation temperature of the pure water at atmospheric pressure (100° C.). Then the saturation conditions of the pure water in the chamber (T_{ch}=100° C. and P_{ch}=101.3 kPa, T_{ch} and P_{ch} were measured by a K-thermocouple and a piezo-electric pressure sensor) and were maintained with the PID system after point b .Thereafter, only the temperature of the sample was gradually increased by a specific sample heater (A ceramic cartridge Acim Jouanin 6.5×32×175 of 175 Watts in a copper housing). This first increase of the sample temperature is called 1° ramp (b-c) and was systematically performed as a blank in order to remove all the peculiarities of the initial conditions in the setup cell and on the surface of the sample. After reaching a sample temperature of 130° C., the sample temperature was decreased (c-d) back to 100° C. (saturation conditions of pure water). Finally, the sample temperature was increased again (points d-e). The thermocouples and pressure gauges are connected to a PC through a data acquisition system. The measuring accuracy of the T and K-thermocouples is 0.5 K, accuracy of the pressure gauge is 5 hPa.

The following samples were tested:
FILM_OPS_H rough: invention coating showing θ_{ECA}=139°
DOT-OPS: biphilic surface according to the invention comprising SH spots and showing different minimum average distance of the grains (m̅i̅n̅D̅i̅s̅t̅) and different average grain size (G̅s̅i̅z̅e̅) as per below table.

| Sample name | m̅i̅n̅D̅i̅s̅t̅ [μm] | G̅s̅i̅z̅e̅ [μm] | % SHS |
|---|---|---|---|
| FILM_OPS_Hrough | 0 | — | 100% |
| DOT_OPS_BIG_HD | 62.75 | 29.19 | 9% |
| DOT-OPS_BIG_LD | 130.50 | 31.01 | 2% |
| DOT_OPS_BIG_ULD | 255.52 | 37.85 | 1% |
| DOT_OPS_SB_LD | 279.92 | 65.37 | 2% |

The average grain size and average minimum distance as well as an evaluation (as per Example 1) of the percentage of surface covered by superhydrophobic spots for relevant coatings tested are graphically represented in FIG. 3.

For the biphilic surfaces, the presence of two degrees of wettability favour the onset of the pool boiling (on surface area of second degree of wettability) but at the same time inhibit the formation of a vapour film (on surface area of first degree of wettability) raising the CHT value compared to a surface completely covered by second degree of wettability (as the FILM_OPS_Hrough). The influence of the average grains size (G̅s̅i̅z̅e̅) and average minimum distance (m̅i̅n̅D̅i̅s̅t̅) on the pool boiling onset temperature (T_{ONB}) for the sample in the table above is shown in FIG. 4. The T_{ONB} is the sample temperature (measure as average of the value of the 3 embedded T-thermocouples) during the sample temperature increase (second ramp d-e FIG. 2) at which the continuous formation of bubbles from the sample surface (typically in just 1 or 2 points) and the rising of bubbles due to the buoyancy are clearly visible. It is possible to note in FIG. 4 The homogeneous values of T_{ONB} (2° C. of max T_{ONB} difference) during the second ramp for biphilic surface (DOT_OPS) and the invention coating (FILM_OPS) that indicate the proper operating of the grains on T_{ONB} reduction.

FIG. 5 shows the heat flux curves as a function of the sample temperature, for the various tested coatings. As can be seen, sample DOT_OPS_BIG_LD shows the best performance.

### EXAMPLE 4

A thin film of hydrophilic epoxy (SR8500/SD8605) dissolved in THF and xylene was deposited on a stainless steel substrate by spin-coating of 0.5 ml solution at 3000 rpm during 2 min. In a second step, spots of OPS_BIG composition (table 1) were applied onto the surface by the spraying technique described here above for the preparation of biphilic surfaces (spray distance 120 cm, aliquot 0.25 ml×5 times). The resulting coating was allowed to cure in an oven at 60° C. for 16 hours. It is understood that superhydrophobic (SH) grains are partially immersed and surrounded by the epoxy layer serving as a glue preventing the grains from detaching from the coated surface. As a consequence, improvement of the coating durability is expected. The sample prepared by this method is called DOT_OPS_BIG_HD_EPOX_HPi.

In a further experiment, a first layer of hydrophilic epoxy (SR8500/SD8605) dissolved in THF and xylene was sprayed on a stainless steel substrate. Next, glass microspheres (diameter≈1000 micron) were deposited on top of this first layer covering the complete surface under evaluation. In a third step, a homogenous film of the SH polymeric composition (OPS_BIG) was applied by spraying (Spray distance 50 cm aliquot 0.5 ml×5 times). The resulting coating was allowed to cure in an oven at 60° C. for 16 hours. Finally, the top layer of SH polymeric coating was removed from the top of the glass microspheres, hence forming a generally porous structure with biphilic surface characteristics expected to promote pool boiling heat transfer. It has been found that such surface treatment is particularly resistant to abrasion and durable. The sample prepared by this method is called MS_1000_EPOX_HPi_OPS_B_FILM.

For comparison purposes, a stainless steel surface coated by a first layer of Hpi epoxy and covered with genuine glass microspheres (no additional SH coating) was also prepared. The sample is called herein after MS_1000_EPOX_HPi.

FIG. 6 graphically represents the evaluation of T_{ONB} during the second ramp, with a procedure similar to that of example 3, for the relevant surface treatments. It appears that the presence of glass microspheres increases the temperature required to activate the boiling (T_{ONB}). Indeed in normal conditions an insulating material on the boiling surface, such as glass for the microspheres, generates an increase of the superheat temperature to initiate pool boiling (MS_1000_EPOX_HPI). In contrast, the coating MS_1000_EPOX_HPi_OPS_B_FILM is capable of reducing T_{ONB} down to a value close to the T_{ONB} found for DOT_OPS in example 3, evidencing that the layer of hydrophilic epoxy does not reduce the effect of the super hydrophobic coating called DOT_OPS_BIG_HD_EPOX_HPi.

### EXAMPLE 5

In this example, the samples C_OPS, C_OPS_F, C_OPS_NP_F are tested in a pool boiling experiment using methanol liquid. The preparation of these samples is described in example 1. As the comparator, SS_smooth (a stainless steel surface AISI 316L with a Ra<0.1 μm) was also tested. Methanol is a working fluid used in many phase change heat transfer devices (for example loop thermosiphon or heat pipe system). The liquid used for this experiment is 99.5% pure methanol. The saturation temperature at ambient pressure of methanol is around 64 C. and it has a surface tension (at 20° C.) of 22.7 mN/m (compared to 72.8 mN/m for water).

The apparatus is shown in FIG. 7. The boiling chamber is made of PTFE. A first heater H1 (300 W) is initially used to heat up the methanol at saturation temperature. A PID system (OMEGA© CN77000) connected with a thermocouple (T1) immersed in the liquid, controls the electrical power to the internal heater in order to maintain the liquid temperature at saturation condition during the experiment (Tch=Tsat=64.7° C.). The chamber is open to the ambient on one-side, in order to maintain the methanol in the chamber at ambient pressure Pch=Patm and in contact with air. A second heater H2 (75 W) increases the temperature of the sample, recorded by a thermocouple (Tw) at the bottom of the sample. The pool boiling phenomena is visualized by a high speed camera (Phantom© v5.2m). The saturation conditions of the methanol in this chamber (Tch=64° C. and Pch=Patm, Tch were measured by a K-thermocouple) were maintained with the PID system (that controls the electrical power to heater H1) after point b. A heat flux meter with 3 embedded T-thermocouples (Captec, France) is placed between the heater H2 and the sample. All the thermocouples, and heat flux meter are connected to a computer using a data acquisition system (Agilent A34970A data acquisition/switch unit, USA). The measuring accuracy of the T and K-thermocouples is 0.5 K.

The test procedure is schematically shown at the top-right of FIG. 7. After filling the chamber with pure methanol at ambient temperature (around 20° C.) the temperature of the system (chamber and sample) was increased up to saturation temperature (64° C.). The saturation conditions in methanol are maintained after point b (T_{ch}=64° C. and P_{ch}=Patm) by the PID system. Indeed heater H2 increased gradually only the sample temperature (Tw>Tch=Tsat). FIG. 8 graphically represents the T_{ONB} evaluation, according to a procedure similar to that of Example 3. The OPS coating reduced T_{ONB} by about 11% as compared to a simple stainless steel surface. Improved results can be obtained by fluorination of the coating after the deposition of nanoparticles (C_OPS_NP_F). In this case T_{ONB} is about 25% less than simple stainless steel surface.

### EXAMPLE 6

This example describes a thermal cycle experiment in order to evaluate the maintenance of wettabilities properties and effect on T_{ONB} reduction after a considerable number of thermal cycles. The following samples described above were tested:
DOT_OPS_BIG_HD_EPOX_Hpi
FILM_OPS_Hrough

FIG. 9 shows the apparatus used for the thermal cycle experiment: the two samples were immersed in pure water in a glass chamber. The temperature of the glass chamber was varied by an external recirculation of oil fluid around the glass chamber. The oil was sourced alternatively (using a timed valve) from two different baths (Julabo©). The temperature of each bath was set in order to generate the temperature variation shown at the top-left of FIG. 9. A thermal cycle started with the water at saturation condition (T1=100° C.) at ambient pressure. This condition was maintained for 15 min and thereafter the water temperature (T1) was decreased to 80° C. (no saturation condition) and maintained at this value for 25 min. Thereafter a new cycle was started with T1 at saturation conditions (T1=100° C.). Each cycle lasted 40 minutes, and the cycles were repeated respectively 156 and 506 times.

A water reservoir was connected with the bottom of the water chamber in order to compensate for loss by evaporation. The water temperature (T1) was recorded during the test using a K-thermocouple inside the water chamber and a data logger to record it (Omega© TC-8).

FIG. 10 shows the results of the durability test. A measurement of the equilibrium static contact angle (using a KrüDSA 100) was carried out on FILM_OPS_H rough after 0-59-156 cycles (plot on the top in FIG. 10). The equilibrium static contact angle remains essentially constant (within the tolerance margin of contact angle measurement); this demonstrates that the wettability properties after N-cycles (156-506) are maintained. In addition, the evaluation of T_{ONB} for both samples (DOT_-OPSS_-BIG_-HD_-EPOX_-Hpi and FILM_OPS_Hrough), according to a procedure similar to the one explained in Example 3, are presented in FIG. 10 (plot in the middle for FILM_OPS_Hrough and at the bottom for DOT_-OPSS_-BIG_-HD_-EPOX_-Hpi). No significant degradation of the effect of wettability on T_{ONB} reduction (T_{ONB} is almost constant for all N-cycle) has been noticed.

1. An omniphobic surface coating comprising a polymer, fluorine molecules or radicals dispersed therein, and microparticles or nanoparticles of crystallized crystalline and/or semi-crystalline polymer dispersed therein and/or other nanoparticles dispersed therein.

2. The omniphobic surface coating of claim 1, comprising a fluor-modified polymer and microparticles or nanoparticles of crystallized crystalline and/or semi-crystalline polymer dispersed therein and/or other nanoparticles dispersed therein.

3-34. (canceled)

35. The omniphobic surface coating of claim 1, wherein the fluor-modified polymers are based on fluorinated epoxy based polymers, preferably high and low molecular weight epoxy resins curable by homopolymerisation or with a curing agent (or hardener) selected from polyfunctional amines, acids, alcohols and thiols, preferably phenol based epoxy polymers, most preferably selected from bisphenol A epoxy resin, bisphenol F epoxy resin, novolac epoxy resin, for example a biobased epoxydized material obtained from cardanol, such as NC-514 cardanol based epoxy polymers, perfluoroalkene, perfluorocycloalkene, fluoroethylene, vinylfluoride, vinylidene fluoride, tetrafluoroethylene, chlorotrifluoroethylene, fluoropropylene, perfluoropropylvinylether, perfluoromethylvinylether or copolymers thereof.

36. The omniphobic surface coating of claim 1, wherein the crystalline and/or semi-crystalline polymer and/or the nanoparticles are present in a weight ratio to the fluor-modified polymer such that the polymer composition shows enhanced omniphobic properties.

37. The omniphobic surface coating of claim 36, wherein the ratio ranges from 20:80 to 80:20, preferably from 25:75 to 75:25, or 25:70 to 50:50.

38. The omniphobic surface coating of claim 1, wherein the crystalline and/or semi-crystalline polymer is selected from polypropylene (PP), preferably isotactic polypropylene, carnauba wax, polycarbonate (PC), polymethylmethacrylate (PMMA), polylactic acid (PLA), polyhydroxyalkanoates (PHA), polyhydroxybutyrate (PHB), polyamide (PA 11, PA 410), starch-based plastics, cellulose-based plastics, and fibrin-based plastics.

39. The omniphobic surface coating of claim 1, wherein the crystalline and/or semi-crystalline polymer includes homopolymers, copolymers, such as ethylene-propylene block copolymers, random copolymers, graft copolymers, such as polypropylene or polylactic acid grafted with maleic anhydride or acrylic acid, halogenated polymers, surface oxidized polymers, and other modifications known to the skilled person.

40. The omniphobic surface coating of claim 1 wherein the molecular weight of the crystalline or semi-crystalline polymer varies within a range of molecular weights of 1000 to 1000000 Da, preferably between 2000 and 200000 or more preferably between 2500 and 100000 Da.

41. An omniphobic material comprising an epoxy-based polymer and fluorine molecules or radicals dispersed therein, wherein the epoxy-based polymer is selected from bio-based epoxydized material obtained from cardanol curable with a curing agent (or hardener) selected from polyfunctional amines, acids, alcohols and thiols, preferably NC-514.

42. The omniphobic material of claim 41, wherein fluorine is grafted onto the epoxy-based polymer.

43. An omniphobic coating composition comprising a solution of fluor-modified polymer and crystalline and/or semi-crystalline polymer and/or other nanoparticles.

44. The omniphobic coating composition of claim 43, wherein the solvent is selected from xylene, a xylene based solvent system, methyl ethyl ketone, tetrahydrofuran, toluene, dibasic esters, DMSO, limonene, butylal or a mixture thereof.

45. The omniphobic coating composition of claim 43, comprising the crystalline and/or semi-crystalline polymer in a weight ratio to the fluor-modified polymer of 20:80 to 80:20, preferably 25:75 to 75:25 or 25:70 to 50:50.

46. The omniphobic coating composition of claim 43, wherein the crystalline and/or semi-crystalline polymer is selected from polypropylene (PP), preferably isotactic polypropylene, carnauba wax, polycarbonate (PC), polymethylmethacrylate (PMMA), polylactic acid (PLA), polyhydroxyalkanoates (PHA), polyhydroxybutyrate (PHB), polyamide (PA 11, PA 410), starch-based plastics, cellulose-based plastics, and fibrin-based plastics.

47. The omniphobic coating composition of claim 43, wherein the fluor-modified polymers are based on perfluoroalkene, perfluorocycloalkene, fluoroethylene, vinylfluoride, vinylidene fluoride, tetrafluoroethylene, chlorotrifluoroethylene, fluoropropylene, perfluoropropylvinylether, perfluoromethylvinylether or copolymers thereof.

48. A process for the preparation of an omniphobic surface coating, comprising applying an omniphobic coating composition according to claim 43 onto a surface, and allowing for solvent evaporation under suitable conditions for crystal rearrangement.

49. The process of claim 48, wherein the solvent evaporation is effected at a minimum temperature of about 15° C. below the melting point of the crystalline and/or semi-crystalline polymer, preferably at a minimum temperature of about 10° C. below the melting point of the crystalline and/or semi-crystalline polymer, more preferably a minimum temperature of about 5° C. below the melting point of the crystalline and/or semi-crystalline polymer., and at a maximum temperature such as to allow for rearrangement of the crystal structure of the crystalline and/or semi-crystalline polymer and formation of nanoparticles and/or microparticles of crystallized crystalline or semi-crystalline polymer of 25° C. beyond the melting point of the crystalline or semi-crystalline polymer, preferable 15° C. beyond the melting point of the crystalline or semi-crystalline polymer, in a temperature range of from 5-10° C. below to 5-10° C. above melting point of the relevant crystalline or semi-crystalline polymer in the solution.

50. The process of claim 48, wherein the process steps are repeated, preferably up to two to three times.

51. The process of claim 48, wherein the coating obtained is overcoated with a layer of epoxy resin, preferably an epoxy resin derived from cardanol, such as NC-514, possibly fluorinated.

52. A biphilic substrate surface, such as for instance a heat exchanging surface of a pool boiling heat exchanger, comprising 50.0-99.9% of the surface showing a first degree of wettability defined by a first liquid-solid contact angle and 0.1 to 50.0% of the surface showing a second degree of wettability to the said liquid, wherein the second degree of wettability is defined by a second liquid-solid contact angle at least 10° higher than first liquid-solid contact angle, and the surface area of second degree of wettability comprising a multitude of discrete surface areas of second degree of wettability dispersed over the substrate surface, wherein the surface area showing the second degree of wettability is formed by a surface material selected from (i) a polymer material comprising a matrix of amorphous polymer showing a contact angle with said liquid higher than 15°, preferably higher than 25° or higher than 35° or 45°, more preferably higher than 55° or 65°, even more preferably higher than 75° or 85°, more particularly higher than 90° and microparticles or nanoparticles of crystallized crystalline and/or semi-crystalline polymer dispersed therein, wherein the crystalline and/or semi-crystalline polymer is present in a weight ratio to said amorphous matrix polymer such that the polymer surface material shows a significantly increased value for the contact angle to said liquid, and wherein the crystalline and/or semi-crystalline polymer is selected from polypropylene (PP), preferably isotactic polypropylene, carnauba wax, polycarbonate (PC), polymethylmethacrylate (PMMA), polylactic acid (PLA), polyhydroxyalkanoates (PHA), polyhydroxybutyrate (PHB), polyamide (PA 11, PA 410), starch-based plastics, cellulose-based plastics, and fibrin-based plastics; (ii) a polymer material comprising a matrix of amorphous polymer showing a contact angle higher than 15°, preferably higher than 25° or higher than 35° or 45°, more preferably higher than 55° or 65°, even more preferably higher than 75° or 85°, more particularly higher than 90° and nanoparticles; or (iii) fluorine-modified epoxy-based polymer.

53. The biphilic substrate surface of claim 52, wherein the surface material comprises the crystalline and/or semi-crystalline polymer in a weight ratio to the amorphous matrix polymer of 20:80 to 80:20, preferably 25:75 to 75:25, or 25:70 to 50:50, and in such proportion that the polymer composition shows significantly increased contact angle.

54. The biphilic substrate surface of claim 52, wherein the surface material comprises nanoparticles in a weight ratio to amorphous polymer of 20:80 to 80:20, preferably 25:75 to 75:25, or 25:70 to 50:50, and in such proportion that the polymer composition shows significantly increased contact angle.

55. The biphilic substrate surface of claim 52, wherein the amorphous matrix polymer is selected from polystyrene (PS), polyethylene (PE), preferably low density polyethylene (LDPE), and polychloroprene (PCP), and from polymers which do not show a high interface contact angle (higher than 15°, 25°, 35°, 45°, 55°, 65°, 75°, 85° or 90° with relevant liquid by themselves but which are functionalized such as to show high contact angle, like polyurethane (PU), polyvinylacetate (PVA), polyacrylic acid, polyacrylate, and epoxy resins.

56. The biphilic substrate surface of claim 52, wherein the crystalline and/or semi-crystalline polymer is polypropylene, preferably isotactic polypropylene.

57. The biphilic substrate surface of claim 52, wherein the crystalline and/or semi-crystalline polymer comprises homopolymers, copolymers, such as ethylene-propylene block copolymers, random copolymers, graft copolymers, such as polypropylene or polylactic acid grafted with maleic anhydride or acrylic acid, halogenated polymers, surface oxidized polymers, and other modifications known to the skilled person.

58. The biphilic substrate surface of claim 52, wherein the weight of the crystalline or semi-crystalline polymer varies within a range of molecular weights of from 1000 to 1000000 g/mol, preferably between 5000 and 500000 or more preferably between 5000 and 300000 g/mol.

59. The biphilic substrate surface of claim 52, wherein the nanoparticles are organic or inorganic or a mixture thereof, possibly treated or functionalized for increased interface contact angle with said liquid, advantageously inorganic nanoparticles, preferably selected from metal oxides, SiO2 or TiO2.

60. The biphilic substrate surface of claim 52, wherein the amorphous matrix polymer comprises an epoxy resin showing an interface contact angle of more than 35°, preferably more than 55°, more than 65° or more than 75° or 85° or even 90° with the said liquid.

61. The biphilic substrate surface of claim 52, wherein the amorphous hydrophobic matrix polymer comprises an epoxy resin rendered hydrophobic by chemical modification, crosslinking or other methods known per se, such as bisphenol A epoxy resin, bisphenol F epoxy resin, novolac epoxy resin, a biobased epoxydized material obtained from cardanol, for example NC-514.

62. The biphilic substrate surface of claim 52, wherein the difference of contact angle is at least 20°, more preferably at least 30°, more preferably at least 40°, more preferably at least 50°, more preferably at least 60°, more preferably at least 70°, for example at least 80°, at least 90°, at least 100°, at least 120°, at least 150°.

63. The biphilic substrate surface of claim 52, wherein the surface material of second degree of wettability is a coating applied onto and bonded to the substrate surface by way of an intermediate binding layer.

64. The biphilic substrate surface of claim 52, wherein the surface area showing the first degree of wettability is an untreated or treated metallic surface, preferably with a surface roughness below 1 μm, such as for instance stainless steel or aluminium or copper, or a substrate surface coated with a coating that shows the required wettability character.

65. A process for the manufacture of a biphilic substrate surface according to claim 54, comprising spraying a solution of the surface material polymer of second degree of wettability as discrete areas over a substrate surface at a distance from the target surface and at a rate such as to spray spots of said surface material polymer of second wettability degree onto the substrate target surface, the total surface of second degree of wettability being 5 to 50% of the total substrate surface.

66. The process of claim 65, wherein the solvent is selected from xylene, a xylene based solvent system, methyl ethyl ketone, DMSO, limonene, butylal or a mixture thereof.
